(19) United States
(12) Patent Application Publication
(10) Pub. No.: US 2006/0233237 A1
(43) Pub. Date: Oct. 19, 2006

(54) Single pass constrained constant bit-rate encoding

(75) Inventors: Jian Lu, Sunnyvale, CA (US); Wenqing Jiang, San Jose, CA (US); Gregory Kent Wallace, Palo Alto, CA (US)

Correspondence Address: FISH & RICHARDSON P.C., PO BOX 1022, MINNEAPOLIS, MN, 55440-1022, US

(73) Assignee: APPLE COMPUTER, INC.

(21) Appl. No.: 11/108,157

(22) Filed: Apr. 15, 2005

(51) Int. Cl. H04N 11/04; H04N 7/12; H04B 1/66; H04N 11/02

(52) U.S. Cl. 375/240.03; 375/240.12

(57) ABSTRACT

Data, such as video data, is encoded by identifying a data segment to be encoded. The data segment includes multiple frames. A bit-rate profile for encoding the data segment is generated. The bit-rate profile defines a number of bits associated with each frame in the data segment. Frames are encoded using the bit-rate profile. The bit-rate profile is updated periodically to incorporate past encoding statistics and compensate for any encoding bits deviations from the initial profile.

### CROSS-REFERENCE TO RELATED APPLICATIONS

This application is related to U.S. patent application Ser. No. ______, [Attorney Docket No. P3836US1/18814-009001], entitled “Selective Reencoding for GOP Conformity”, filed Apr. 15, 2005, which is incorporated herein by reference.

### BACKGROUND

This description relates to editing and encoding video, and more particularly to single-pass constrained constant bit-rate encoding.

A video editing application allows a user to generate an output video sequence from various video sources. A video camera can capture and encode video information that can be used as one or more video sources. A user can make edits to create a video sequence composed of desired portions of the video sources. Some video editing applications encode the video sources to an intermediate format prior to editing. However, this technique is time-consuming and processor-intensive on the front-end as each video source has to be processed before it can be edited. Furthermore, transforming video from one format to another causes generational quality loss. Other video editing applications encode an entire video sequence after editing. But this technique is time-consuming and processor-intensive on the back-end and also reduces video quality. Video editing applications that enable edited video to conform to native formats (e.g., a format that is native to a video camera, such as HDV) can, among other things, help maintain video quality and provide increased flexibility in using the edited video. For example, video that is edited in a native format can be written back to a source device (e.g., a camera).

Some encoders for video sources use MPEG (Motion Pictures Expert Group) standards, such as MPEG2, which is used by HDV. MPEG encoding uses intraframe compression techniques to reduce the size of certain frames (i.e., I-frames), and interframe compression techniques to reduce the size of other frames (i.e., P-frames and B-frames) in a sequence of frames. An I-frame can be reconstructed without reference to other frames, a reconstruction of a P-frame is dependent upon the last I-frame or P-frame, and a reconstruction of a B-frame is dependent upon two frames selected among the preceding and following I-frames and P-frames. For interframe compression, MPEG video clips are segmented into GOPs (Groups of Pictures) that include an independent I-frame and dependent P-frames and B-frames. The P-frames and B-frames can be dependent not only on source frames within a GOP, but also on source frames in neighboring GOPs. An MPEG decoder used to display MPEG video clips includes a buffer to store reference frames while decoding dependent frames. In some MPEG implementations, if designed properly, the hypothetical VBV buffer can be subject to an overflow condition when an outgoing data rate of the MPEG video clip is too low to keep up with a display rate and subject to an underflow condition when a data rate is too high to store necessary frames.

Constant bit-rate (CBR) encoding is a type of rate control technique that is commonly used in digital video encoders such as an MPEG2 encoder. In MPEG2 and other standards-based encoders such as H.264, a constant bit-rate encoder achieves an average target bit rate by regulating a virtual buffer such that the buffer level fluctuates smoothly within an allowable range specified by the standards. Accordingly, while a constant bit-rate encoder does not achieve an absolutely unvarying bit rate, it does achieve a relatively constant bit rate relative to a variable bit-rate encoder, which allows a much wider range of fluctuations in bit rates. Generally, constant bit-rate encoders are permitted to start with an arbitrary buffer level, if the decoder initial startup delay is not a concern, fluctuate within the allowable range, and end at any buffer level within the allowable range.

### SUMMARY

In situations where nonlinear editing is performed in a native interframe format, a conventional constant bit-rate encoder is not suitable. Unlike linear editing, where an entire sequence of frames is encoded from beginning to end, nonlinear editing can involve encoding edited segments of a video sequence that fall between unedited segments of the video sequence. Thus, native interframe format video editing involves rendering and re-encoding each edited segment of a video sequence in its native format, and leaving unedited segments untouched. If a conventional constant bit-rate encoder is used, edited segments are allowed to arbitrarily fluctuate within an allowable buffer level range. The surrounding unedited segments are encoded, however, based on specific starting and ending buffer levels. Thus, if edited segments are encoded with a conventional constant bit-rate encoder, the edited segment may end with an arbitrary buffer level that is different from the starting buffer level of the following unedited segment. Especially after encoding multiple edited sequences, such differences can result in a buffer level drift that can cause an overflow or underflow condition.

To avoid drifts and, in the case of a native MPEG2 format, to ensure that each edited segment is part of an overall MPEG2-compliant sequence, a rendered and re-encoded edit needs to retain the original buffer levels at the boundaries of the edited sequence (i.e., the two ends of the edited video segment) for the edit to fit in the sequence that remains compliant to the MPEG2 specifications. A constrained constant bit-rate encoder and algorithm makes it possible for any edit to fit in seamlessly at any requested point in a MPEG2 sequence that may be a composition of edited and unedited segments.

In one general aspect, data is encoded by identifying a data segment to be encoded. The data segment includes multiple frames. A bit-rate profile for encoding the data segment is generated. The bit-rate profile defines a number of bits associated with each frame in the data segment. Frames are encoded using the bit-rate profile.

Implementations can include one or more of the following features. Generating a bit-rate profile includes allocating a number of bits for each frame based on a type of interframe dependency for the frame. The data segment is a second portion of an edited video segment, and a first portion of the edited video segment is encoded using constant bit-rate encoding. A bit-rate profile for encoding the data segment is iteratively generated and each frame in a group of frames is encoded using the bit-rate profile. A new bit-rate profile is generated for remaining frames in the data segment after each encoding of a group of frames. The data segment includes an edited video segment in a video sequence. The video sequence includes a video segment adjacent to the edited video segment, and the adjacent video segment has an associated buffer state used in generating the bit-rate profile. Encoding frames using the bit-rate profile involves adapting an encoding bit-rate to correspond to the bit-rate profile and/or selecting one or more quantization levels for encoding a frame based on the number of bits associated with the frame from the bit-rate profile. The quantization level is a quantization step size or a scaling factor and the selected quantization level allows encoding of the frame using a number of bits within a predetermined threshold of the number of bits associated with the frame. The bit-rate profile is associated with a calculated buffer level for storage of bits from a data sequence that includes the data segment. Generating the bit-rate profile is based on an average target bit rate, a maximum calculated buffer level, a minimum calculated buffer level, and/or one or more boundary conditions for the calculated buffer level.

A data sequence to be encoded is identified, and the data sequence includes the data segment. A determination is made that a length of the data sequence exceeds a threshold, and a portion of the data sequence is encoded in accordance with a target encoding bit rate (i.e., the average target bit rate) in response to determining that the length of the data sequence exceeds the threshold. A result of encoding the portion of the data sequence provides one of the boundary conditions associated with the data segment to be encoded. The boundary conditions include a calculated buffer level for a first data segment preceding the data segment to be encoded and a calculated buffer level for a second data segment following the data segment to be encoded. The frames are partitioned into groups of frames and a number of bits is re-allocated to each remaining un-encoded frame in the data segment after encoding each group of frames. The encoder is repeatedly adapted to encode a remaining un-encoded frame based on a re-allocated number of bits, and a number of bits is repeatedly re-allocated to each remaining un-encoded frame in the data segment after encoding each group of frames.

A compression rate for each frame is adapted to encode each frame using a number of bits within a predefined limit of the allocated number of bits. A compression rate is selected that does not result in using a number of bits that exceeds the allocated number of bits. A number of bits allocated to each frame is calculated using a ratio between a number of bits for I-frames, a number of bits for P-frames, and/or a number of bits for B-frames. A selection, for use in calculating a number of bits allocated to each frame, of a relatively higher ratio of a number of bits for P-frames to a number of bits for I-frames or a number of bits for B-frames to a number of bits for I-frames is favored. An allocated number of bits for one or more frames is adjusted to prevent a calculated buffer from violating a minimum threshold. The allocated number of bits is calculated for each frame to enable the encoded video segment to comply with the boundary conditions and to maintain a substantially consistent video quality.

In another general aspect, a video segment to be encoded is identified. The video segment includes multiple frames. A beginning boundary condition and an ending boundary condition are identified for encoding the video segment. Each boundary condition includes a calculated buffer level. A number of bits allocated to each frame in the video segment is calculated. The allocated number of bits are for encoding each frame to maintain a substantially consistent video quality and to ensure that the calculated buffer level does not exceed a maximum threshold for the calculated buffer level or fall below a minimum threshold for the calculated buffer level. In addition, the allocated number of bits are for ensuring that the encoded video segment satisfies the ending boundary condition. Changes in the calculated buffer level are associated with differences between an encoding bit rate for the frames and a target encoding bit rate. An encoder is adapted to encode each frame using approximately the allocated number of bits for the frame.

The details of one or more implementations are set forth in the accompanying drawings and the description below. Other features will be apparent from the description and drawings, and from the claims.

### DESCRIPTION OF DRAWINGS

FIG. 1 is a block diagram for illustrating the operation of a video encoding and decoding process.

FIG. 2 is a graph illustrating a state of a virtual buffer verifier for a constant bit-rate encoder.

FIG. 3 is a block diagram of a constrained constant bit-rate encoder system.

FIG. 4 is a schematic diagram of a hybrid encoding technique.

FIG. 5 is a flow diagram of a constrained constant bit-rate encoding process.

FIG. 6 is a flow diagram of a constrained constant bit-rate profile generation algorithm.

FIG. 7 is a flow diagram of an algorithm for finding a bit allocation for the frames in each GOP.

Like reference symbols in the various drawings indicate like elements.

### DETAILED DESCRIPTION

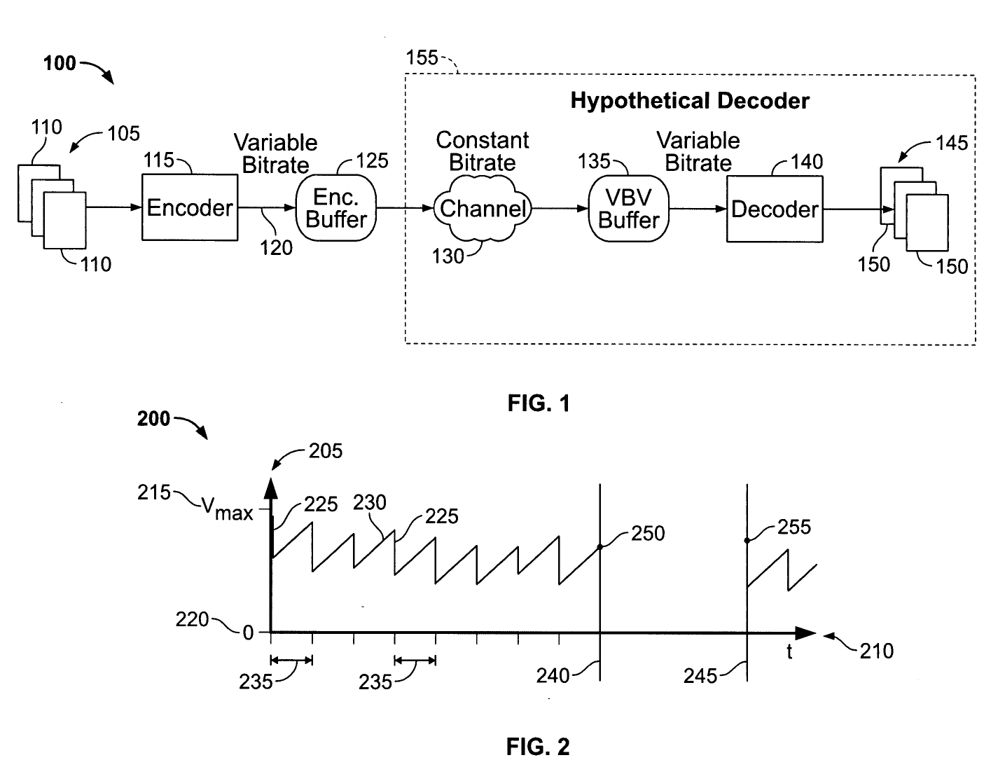

FIG. 1 is a block diagram for illustrating the operation of a video encoding and decoding process 100. An input video sequence 105 includes a series of sequential frames 110. A typical video stream, for example, uses a frame rate of thirty frames per second. The frames 110 are encoded by an encoder 115, such as an MPEG2-compliant encoder. In MPEG2 encoding, the frames 110 are reordered from a display order to a transmission order, as known by persons of ordinary skill. In addition, the size of the encoded frames vary depending on the complexity of the frame and the type of dependency on another frame. Thus, the encoded video sequence 120 has a variable bit rate.

Many video applications, however, require video data to be provided at a constant bit rate. In such applications, the encoder 115 typically makes calculations to account for buffer loads and/or processing demands on a hypothetical decoder 155. The hypothetical decoder 155 may or may not represent an actual decoder but can be used to illustrate the conceptual design of the encoder 115. To account for the hypothetical decoder's 155 need to receive data at a constant bit rate, video data is transferred over a data channel 130 at a constant bit rate. For example, transferring video data to and from a digital video camera generally uses a constant bit rate. The constant bit rate generally varies depending on the particular application. For example, video transmitted using DSL typically uses a rate of about 300K bits/second, while 1080i video encoding uses a rate of about 25 M bits/second. In a constant bit-rate encoder, video data is generally buffered to account for the reordering of frames by the encoder 115 and for the variable bit rate of the encoded video sequence.

Variations in the amount of buffered data are permitted within an allowable range. If data is buffered at a faster rate than data is used for decoding, an overflow condition will eventually occur, in which the amount of buffered data exceeds a maximum threshold. An overflow condition can occur, for example, if too many simple frames are encoded consecutively. An overflow condition can be easily addressed, however, by packing extra unused or unnecessary bits in a frame, or by intentionally encoding a frame in an inefficient manner. If data is used for decoding at a faster rate that data is buffered, an underflow condition will eventually occur, in which there is not enough buffered data to decode a video frame. An underflow condition can occur, for example, if too many complex frames are consecutively encoded. An encoder buffer 125 monitors an amount of buffered data. The encoder buffer 125 can be used to buffer data for storage on a storage medium or for transmission over a constant bit rate channel (e.g., data channel 130). In some cases, the encoder buffer 125 is not an actual buffer (e.g., if data is written to a file instead of sent over a data channel) but is a virtual buffer used to emulate the amount of buffering necessary to decode the encoded video sequence 120.

In the hypothetical decoder 155, data enters a virtual buffer verifier (VBV) 135 from the data channel 130 at a constant bit rate. In some cases, the virtual buffer verifier 135 is a calculated buffer level, which can but does not necessarily correspond to an actual buffer level. Data is extracted from the VBV 135 at a variable rate, depending on the amount of data used to encode each frame. In particular, a decoder 140 extracts video data from the buffer 135 at a variable rate that corresponds to the variable rate at which the encoder 115 generates the encoded video sequence 120. The decoder 140 decodes the extracted video data to produce a video sequence 145 having frames 150 corresponding to the input video sequence 105.

FIG. 2 is a graph 200 illustrating a state of a virtual buffer verifier for a constant bit-rate encoder. The state or level of the virtual buffer verifier can be measured in terms of a number of stored bits or a VBV delay, which represents an amount of time for the buffer to be filled to its current level. Because the buffer is filled at a constant bit rate, the number of stored bits and the VBV delay can be mapped to one another. For purposes of this description, the number of stored bits for the virtual buffer verifier and the VBV delay can be referred to as a calculated buffer level or calculated buffer state. The graph 200 illustrates a VBV level along a vertical axis 205 and time along a horizontal axis 210.

When encoding a constant bit-rate video sequence, the VBV level cannot exceed a maximum level 215 (e.g., 7,340,032 bits for an MPEG-2 main profile at high 1440 level) or fall below a minimum level 220 (e.g., 0 bits). The initial VBV level can be arbitrarily selected. In this example, the initial VBV level is set at the maximum VBV level. When a frame is displayed (or data corresponding to a frame is extracted from the buffer for decoding), the VBV level decreases (225) by an amount corresponding to the size of the encoded frame in number of bits. Because data enters the VBV at a constant rate corresponding to the bit rate of the data channel, the VBV is filled at a constant bit rate (230). Each frame is displayed for a predetermined amount of time (i.e., the frame duration 235), which corresponds to the frame rate. Accordingly, while each frame is displayed, the VBV fills at a constant rate until the next frame is displayed, at which time the VBV level again decreases (225) by an amount corresponding to the size of the next encoded frame. In this manner, the VBV level fluctuates over time.

To maintain the VBV level within the permissible range, an average target encoding bit rate is defined. The average target encoding bit rate corresponds to the constant bit rate associated with the data channel for the particular application. By attempting to track the average target encoding bit rate (e.g., following a frame having a relatively high encoding bit rate with a frame having a relatively low encoding bit rate to effectively average out the overall encoding bit rate), the VBV level can be maintained within the allowable range even though the encoding bit rate may vary widely for individual frames.

To prevent underflow or overflow conditions, a constant bit-rate encoder needs to monitor a buffer or VBV level and adjust encoding rates accordingly. At the same time, it is generally desirable to maintain the best possible video quality, which includes a consistent video quality over time. Accordingly, a constant bit-rate encoder generally attempts to avoid situations, for example, in which complex frames need to be encoded using a relatively small number of bits to avoid an underflow condition or in which simple frames are inefficiently encoded, thereby using large numbers of bits, at the expense of encoding quality of subsequent complex frames.

Conventional constant bit-rate encoders are unconstrained in that the buffer level can be arbitrary at the beginning of a video sequence and can end at any arbitrary level, provided that the buffer level remains within the maximum and minimum thresholds. In other words, constant bit-rate encoders do not have boundary conditions.

In accordance with some aspects of the present invention, a constrained constant bit-rate (CCBR) encoder enables buffer levels at both the beginning and end of a video sequence to be constrained to a particular level. In other words, the constrained constant bit-rate encoder can generate a video sequence that begins with a buffer level having a first particular value and ends with a buffer level having a second particular value. Such a result can be used, for example, to selectively re-encode edited portions of an overall video sequence, as described in U.S. patent application Ser. No. ______ (Attorney Docket No. P3836US1/18814-009001, entitled “SELECTIVE REENCODING FOR GOP CONFORMITY”, filed Apr. 15, 2005. Selective re-encoding can be used to allow editing of segments in a video sequence without needing to re-encode the entire sequence, which includes unedited segments. Edited segments can include segments to which video effects are added or segments from different sources that are spliced together. Alternatively or in addition, edited segments can include frame sequences that need to be re-encoded because they span a boundary of an added video effect or span a boundary between different video sources that are spliced together.

When a video segment within an overall video sequence is to be re-encoded, the buffer levels at the boundaries generally need to be continuous to comply with encoding standards and to avoid inadvertent drift in buffer levels, which can lead to overflow or underflow conditions. As shown in FIG. 2, a video segment can be added beginning at a first time 240 until a second time 245. The added video segment can be, for example, a modification of an original video segment from the same time period or a different video segment that is inserted into the video sequence. The unedited portions of the video sequence have corresponding buffer levels that fluctuate in accordance with a previous encoding of the video sequence. The buffer level 250 at the first time 240 is used as a starting buffer level for re-encoding the added video segment, and the buffer level 255 at the second time 245 is used as an ending buffer level for re-encoding the added video segment.

The added video segment is encoded in accordance with the average target encoding bit rate. In addition, the added video segment is encoded in a manner that avoids underflow and overflow conditions. Encoding is performed to maintain a substantially consistent video quality. For example, the encoding bit rate can initially be assumed to uniform for all frames to be encoded. The encoding bit rate can be adjusted, however, depending on the type of frame (e.g., an I-frame, P-frame, or B-frame) and/or the complexity of the frame. The added video segment is also encoded to ensure compliance with the starting and ending buffer levels. In some implementations, an ending buffer level can be targeted a small amount above the actual ending buffer level, and the excess buffer level can be cleared by adding extra bits to the current frame. This small amount provides some encoding simplification and flexibility so that the encoding does not have to produce a precise ending buffer level but can clear the small amount of extra buffer space by adding spare bits, which can be essentially ignored for purposes of decoding but that ensure buffer level continuity at the ending boundary. Alternatively or in addition, the effective target bit rate for one or more frames can be targeted a small amount below the actual budgeted target bit rate.

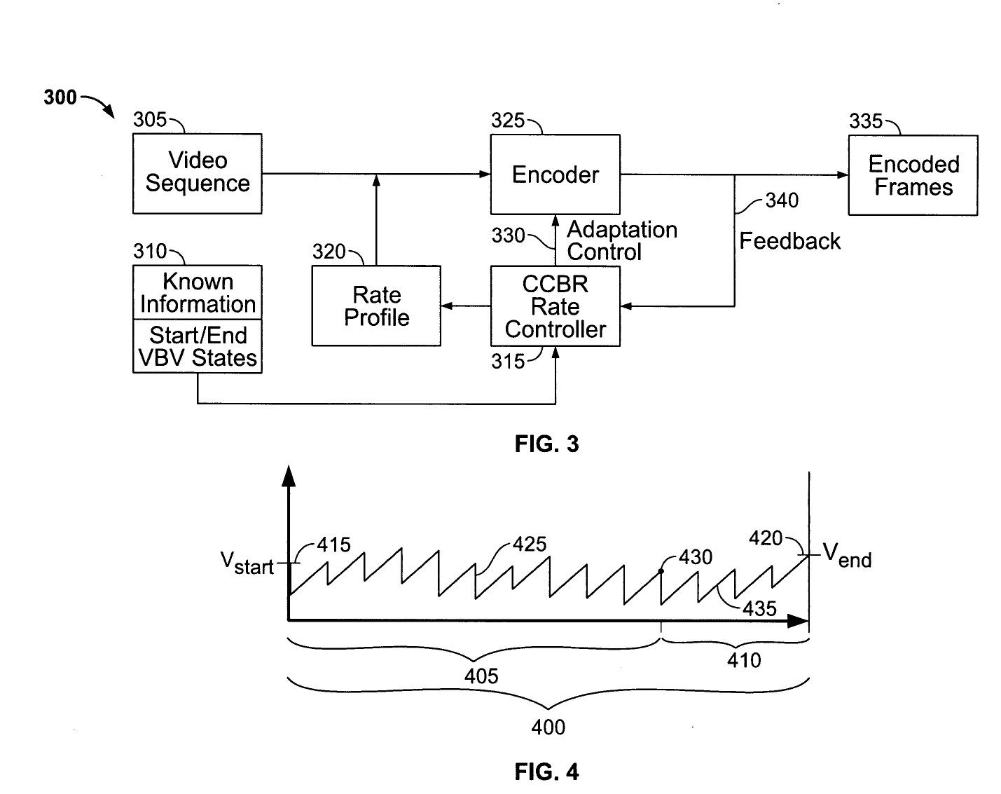

FIG. 3 is a block diagram of a constrained constant bit-rate encoder system 300. Inputs to the system 300 include a video sequence or segment 305 to be encoded and constraints and other known information 310. The other information can include, for example, a size in bits of an original segment that has been edited to create the video segment 305, bit allocations among different frame types (e.g., I-frames, P-frames, and B-frames), and/or a bit rate profile for the frames in an encoded version of the original segment. The information can also include a size in frames of the video sequence 305. The constraints also include the starting and ending buffer or VBV states. A constrained constant bit-rate (CCBR) rate controller 315 receives the constraints and other information 310 and, based on the constraints, generates a rate profile 320 that provides a recommended number of bits to be allocated for encoding each frame of the video segment 305. The number of bits to be allocated generally corresponds to an encoding bit rate times a known frame duration. The rate profile 320 can be generated dynamically and/or using predetermined rate profile parameters (e.g., specifying that more bits should be used for I-frames and less bits should be used for B-frames).

The rate profile 320 is used by an encoder 325 for encoding the frames of the video segment 305. The CCBR rate controller 315 also provides adaptation control 330 to the encoder 325 to ensure that the actual number of bits used to encode the frames follows the rate profile 320 and to adapt to the complexity of the frame content, as necessary. In particular, the adaptation control 330 adjusts compression or quantization levels (e.g., step sizes and scaling factors) used for quantizing encoding data (e.g., DCT coefficients for blocks and/or macroblocks in MPEG2) to control the number of bits used for encoding. The adaptation control 330 can operate to ensure that the number of bits used for encoding are within a tolerance (e.g., a percentage or a number of bits) of the allocated number of bits. The encoder 325 generates encoded frames 335, and the CCBR rate controller 315 receives feedback 340 based on the encoded frames 335 to perform adaptation control 330 and to update the rate profile 320.

The rate profile 320 can be iteratively updated, such that a new rate profile 320 is generated each time the encoder 325 produces an encoded frame 335. Alternatively, new rate profiles 320 can be generated on some other periodic basis (e.g., after each set of three or five encoded frames) or on a non-periodic basis (e.g., a new rate profile 320 is generated only if the actual number of bits used for an encoded frame or a sequence of consecutive encoded frames exceed a threshold). Updates to the rate profile 320 are used to account for variations from the allocated number of bits in encoded frames 335. Such variations can be due to quantization levels that do not produce frames precisely encoded with the allocated number of bits and/or due to allowable variations to account for relative complexities between different video frames.

The adaptation control 330 can also continuously or periodically update quantization levels (e.g., for each macroblock). A prediction of the number of bits needed to encode a macroblock or a frame can be made using a model corresponding to the particular quantization level used. In some cases, if the number of bits needed to encode a frame falls outside of an allocated number of bits by a predetermined two-sided error bound (e.g., ±5%), a different quantization level can be selected and the number of bits needed can be re-determined until the predicted number of bits is within the error bound, thereby providing encoder adaptation, as described in U.S. patent application Ser. No. 10/751,345, entitled “Robust Multi-Pass Variable Bit Rate Encoding.” In some situations, such as if the encoding process is approaching an ending point or is repeatedly (e.g., for several consecutive frames) exceeding the allocated number of bits in the positive direction, a one-sided error bound (e.g., in the negative direction) can be applied. Such a restriction can result in only allowing undershooting the allocated number of bits and can prevent the use of a number of bits that results in an undesirable decrease in the buffer level.

If a segment to be encoded is sufficiently long, the segment can be partitioned into two portions or sub-segments. A hybrid encoding process that combines conventional constant bit-rate encoding with constrained constant bit-rate encoding can be used on the segment. In particular, a first portion can be encoded using a conventional constant bit-rate encoder, and a second portion can be encoded using a constrained constant bit-rate encoder.

FIG. 4 is a schematic diagram of a hybrid encoding technique. A video segment 400 is partitioned into a first portion 405 and a second portion 410. The video segment 400 includes boundary conditions that need to be met by the encoded version of the video segment 400. The boundary conditions include a starting buffer level 415 and an ending buffer level 420. A constant bit-rate encoder is used on the first portion 405 using the starting buffer level 415 as an initial buffer level for the constant bit-rate encoding. The constant bit-rate encoding is performed in accordance with an average target bit rate and maintaining the buffer level within an allowable range. The constant bit-rate encoder produces a fluctuating buffer level 425 and an arbitrary final buffer level 430 for the encoded version of the first portion 405. A constrained constant bit-rate encoder is then used on the second portion 410 using the arbitrary final buffer level 430 as a starting buffer level and the ending buffer level 420 as an ending boundary condition. The constrained constant bit-rate encoder encodes the second portion 410 in accordance with the average target bit rate, maintaining the buffer level within the allowable range, and such that a fluctuating buffer level 435 for the encoded version of the second portion 410 satisfies the ending boundary condition.

Hybrid encoding can be beneficial because constant bit-rate encoding can be performed quicker and using fewer processing resources than constrained constant bit-rate encoding. In addition, constant bit-rate encoding can sometimes produce higher quality because it has greater flexibility to account for the relative complexity of the frames to be encoded. Hybrid encoding can be triggered if a video segment to be encoded is longer than a threshold length (e.g., five seconds). When hybrid encoding is used, a minimum length (e.g., sixty frames or two seconds) of the constrained constant bit-rate encoding can be applied. In some implementations and/or in some cases, a minimum length of the constrained constant bit-rate encoding is desirable because it provides a greater number of frames over which to migrate from a starting buffer level to an ending buffer level.

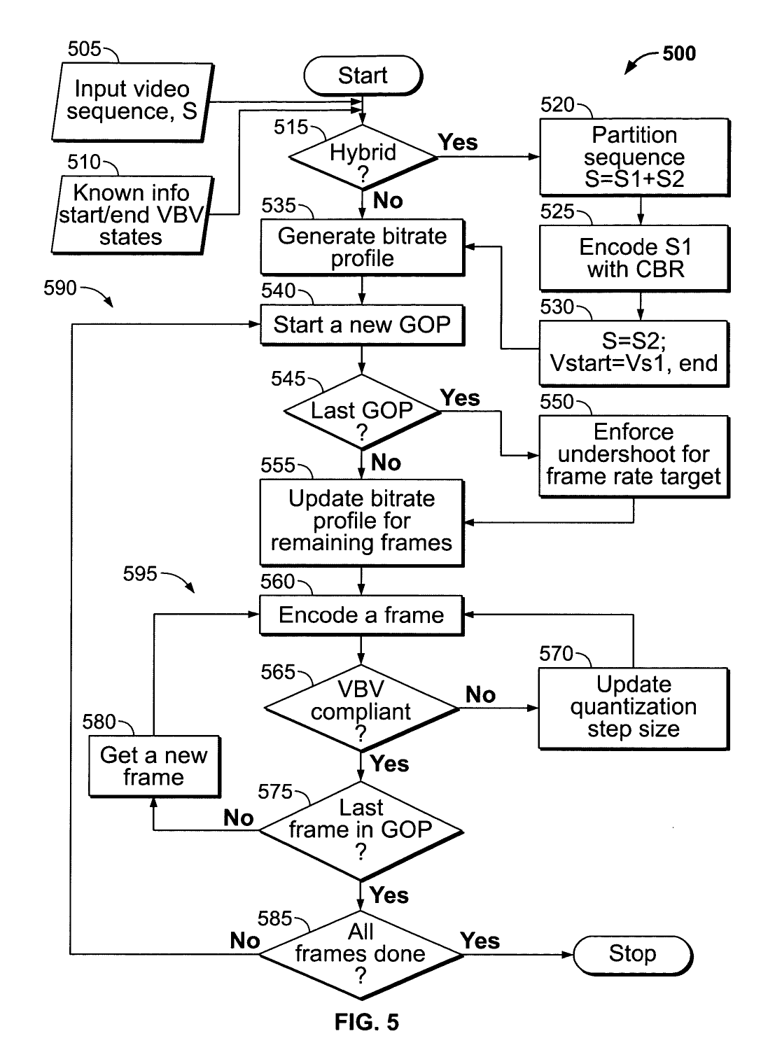

FIG. 5 is a flow diagram of a constrained constant bit-rate encoding process 500. When the process starts, an input video sequence 505 is provided. The input video sequence 505 can include, for example, multiple segments, some of which need to be re-encoded. Known information 510 regarding the input video sequence, including a starting VBV level and ending VBV level for a segment to be encoded, is identified. A determination is made as to whether a hybrid encoding process should be used (515). A decision can be made based on the length of the segment to be encoded and/or on other considerations. If so, the segment S is partitioned into distinct portions S₁ and S₂ (520). The first portion S₁ is encoded with a constant bit-rate encoder using the starting VBV level from the known information 510 as the initial VBV level (525). The VBV level at the end of the encoded first portion S₁ is set as the starting VBV level for constrained constant bit-rate encoding and the portion S₂ is identified as the segment to be encoded using constrained constant bit-rate encoding (530). If a determination is made (at 515) that hybrid encoding is not to be used, the starting VBV level from the known information 510 is used as the initial VBV level for constrained constant bit-rate encoding.

A rate profile specifying target bit rates for each frame in the segment to be encoded is generated (535) based, at least in part, on the known information 510. The target bit rates for all of the frames in the segment are generally selected so as to average out to the average target bit rate for the segment, which corresponds to the constant bit rate for a particular application. The initial bit rate profile (generated at 535) provides an initial estimate of the profile for all of the frames in the segment. In some cases, the initial bit rate profile may simply be a uniform bit rate distribution among all frames in the segment, while in other cases the initial bit rate profile may be further tailored according to, for example, a frame type (I-frame, P-frame, or B-frame) for each frame. In any event, the initial bit rate profile is typically adjusted during a GOP generation and processing loop 590 (at 555, as discussed below).

A new group of pictures (GOP) is started (540), in which several of the frames in the segment to be encoded (e.g., S or S₂) are assigned to a GOP. The number of assigned frames can be predetermined, can be within a predefined range, and/or can be based on the number of frames in the overall segment. If the new GOP is the last GOP in the segment to be encoded (e.g., the GOP encompasses the last fifteen frames in the segment) (as determined at 545), an undershoot restriction for each frame's bit rate target is placed on the GOP or a portion of the GOP (550), as discussed above in connection with the adaptation control 330 of FIG. 3. The undershoot restriction enforces a constraint that prevents the bit rate for each frame from exceeding the target bit rate by, for example, ensuring that the quantization levels result in a sufficient amount of compression to meet or beat the target bit rate. The undershoot restriction helps ensure that the last GOP is encoded in a way that allows the ending VBV value to be met (i.e., to maintain continuity at the segment boundary). The undershoot restriction can be applied to all of the frames in a GOP or to a portion of the frames in the GOP. In general, the undershoot restriction only needs to be applied in the last GOP because the overall constrained constant bit-rate encoding process 500, even without the undershoot restriction, ensures that the VBV level does not stray too far from a target VBV level that corresponds to the bit rate profile. As a result, any variation from the periodically adjusted bit rate profile can be addressed by placing the undershoot restriction on the last GOP.

If the GOP started at 540 is determined not to be the last GOP at 545 and/or once the undershoot restriction has been applied to the GOP, the bit rate profile for the remaining frames in the GOP is updated (555). Even though an initial bit rate profile is generated (at 535), the first frame of the first GOP can still be subject to adjustment in some cases to account for the frame type and/or to prevent a potential underflow error. For subsequent GOPs, the bit rate profile is adjusted to account for accumulated variations from the target bit rates that occur in frames from a previously encoded GOP, to tailor the target bit rate for each frame based on the frame type, and/or to prevent a potential underflow error.

Once the bit rate profile is updated, a frame encoding loop 595 is initiated. A frame is encoded (560) using approximately an allocated number of bits from the rate profile (i.e., according to the target bit rate). To perform the encoding, a quantization level or levels are selected that are predicted to result in an encoded frame that uses the allocated number of bits. The number of bits that will be needed for a given quantization level can be predicted based on, for example, an analysis of frame complexity and/or empirical encoding data for various frame types, quantization levels, image complexities, and the like. Moreover, encoding of the frame can include adapting the encoder, such as by using techniques described in U.S. patent application Ser. No. 10/751,345, entitled “Robust Multi-Pass Variable Bit Rate Encoding.” A check of VBV compliance for overflow or underflow is made (565). If the encoded frame is not VBV compliant, the quantization step size is updated (570), and the frame is re-encoded using the updated quantization step size at 560. A determination is made as to whether all frames of the video segment have been encoded (575). If not, the frame encoding loop 595 selects the next frame in the GOP (580) and returns to 560 where the next frame is encoded (560) using the current rate profile as determined by the most recent bit rate profile update (at 555). A determination is made (585) as to whether all frames have been encoded. If not the GOP generation and processing loop 590, starts a new GOP (at 540). Once all frames have been encoded, constrained constant bit-rate encoding of the segment is complete and the process 500 ends.

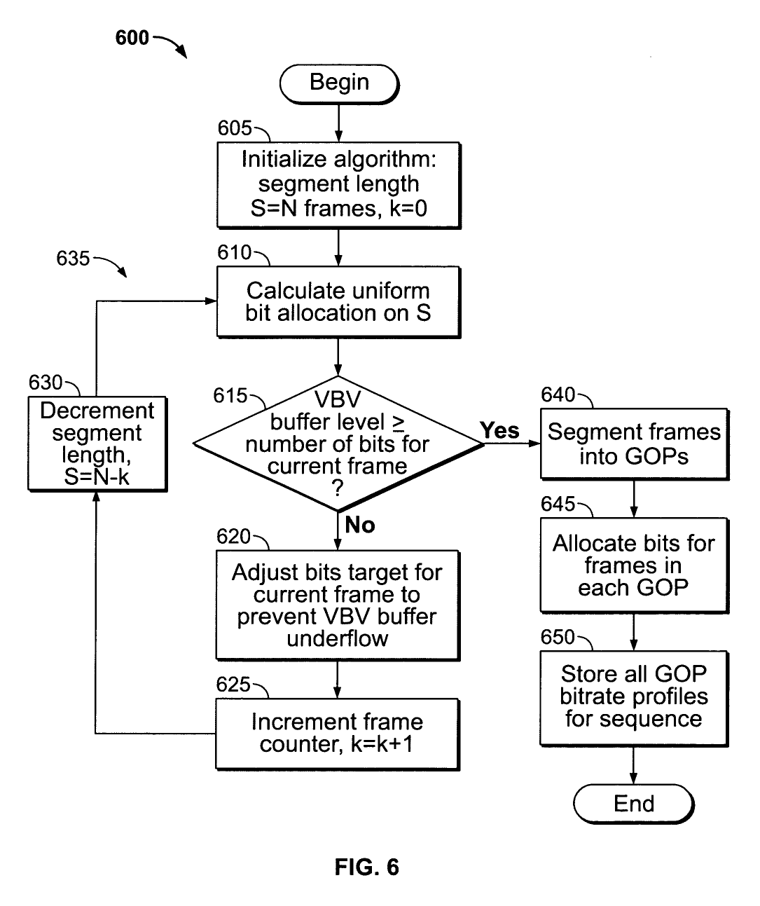

FIG. 6 is a flow diagram of an algorithm 600 for generating and updating a CCBR bit-rate profile, such as can be implemented in FIG. 5 (see rate profile generation and updating 535 and 555). Operation of the algorithm 600 involves allocating a bit rate profile P for N frames in a segment using an average encoding bit rate R (i.e., the average target bit rate or constant bit rate dictated by the application). The algorithm 600 avoids VBV underflow or overflow, and start and end VBV buffer levels are used as input parameters. The algorithm is initialized (605) by setting an index of a current frame to the first frame (e.g., set k=0 to be the index of current frame, with the segment including frames k=0, 1, . . . N−1); setting a buffer level for the first frame to the starting VBV buffer level (e.g., V₀=Vₛₜₐᵣₜ); setting the length S of the segment to be equal to N frames; and calculating the total number of available bits B:
B=R*N/F+(Vₛₜₐᵣₜ−V_{end}),
where F is the frame rate (e.g., 30 frames/second), Vₛₜₐᵣₜ is the starting VBV buffer level, and V_{end} is the ending VBV buffer level.

A uniform bit allocation for all of the frames in the segment to be coded is calculated (610):
Bᵢ=B/(N−k)for i=k,k+1, . . . ,N−1
where Bᵢ is the bit allocation for frame i. Accordingly, each frame is allocated an equal amount of bits. A check is made to determine if the current VBV buffer level is higher than or equal to the bit allocation for the current frame (615):
Vₖ≧Bₖ

If not, the current frame bit allocation is adjusted (620) to prevent an underflow condition (e.g., Vₖ<Bₖ):
Bₖ=a₀*W, with a₀<1.0 and W=R/F,
where W is the number of incoming bits for the current frame duration (i.e., as a result of a constant bit rate data channel). In addition, the VBV buffer level for the next frame is updated as:
Vₖ₊₁=Vₖ−Bₖ+R/F,
and the total available bits is updated:
B=B−B₀.
The frame counter is incremented (625):
k=k+1,
and the segment length is decremented (630):
S=N−k.
The algorithm returns to recalculate a uniform bit allocation for the remaining S frames (610). This underflow avoidance loop 635 is thus repeated until a uniform bit allocation for the remaining S frames produces a situation in which an initial frame does not produce a VBV underflow.

If the current VBV buffer level is higher than or equal to the bit allocation for the current frame (as determined at 615), the frames are segmented into GOPs (640). For example, the N frames are segmented using GOP boundaries (e.g., with each GOP being defined as preferably including fifteen frames for a video source of thirty frames per second, such as 1080i or NTSC). Any frames for which the allocated number of bits have been adjusted to avoid an underflow (at 620) are included in one or more of the GOPs, but the bit allocations for such frames are not adjusted during the subsequent bit allocations. A bit allocation among frames in each GOP is then calculated (645) for the S (i.e., S=N−k) frames that have not already been assigned an allocation (at 620), and a bit profile P for the segment to be encoded, including bit rate profiles for all of the GOPs in the segment, is stored (650).

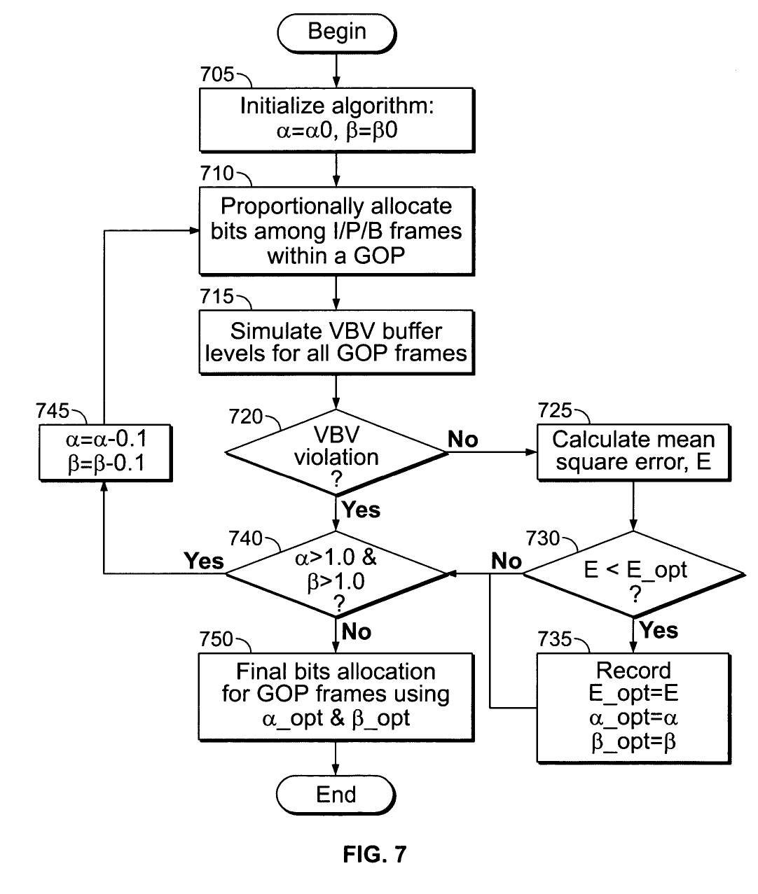

FIG. 7 is a flow diagram of an algorithm 700 for finding a bit allocation for the frames in each GOP as can be used in the algorithm 600 of FIG. 6 (see 645). Basic values for the algorithm 700 are initialized (705) using, for example, prior knowledge or online encoding statistics. The values to be initialized include an initial error value (Eₒₚₜ=E₀, which is typically set at a large number), an initial ratio of the number of bits in I-frames to B-frames (α=α₀) and an initial ratio of the number of bits in P-frames to B-frames (β=β₀). The initialized values can also include a calculation of a budgeted number of bits for the current GOP (Bₙ, where n is the current GOP). The budgeted number of bits is calculated by adding up the bits that are uniformly allocated to the frames in the current GOP.

The budgeted number of bits are proportionately allocated among I-frames, P-frames, and B-frames (710) by starting with a relative number of bits for I-frames (B_{I}), P-frames (B_{P}), and B-frames (B_{B}):
B_{I}=α*B_{B}, B_{P}=β*B_{B} with α>β>1.0,
and solving for a number of bits for B-frames in:
Bₙ=N_{I}*B_{I}+N_{P}*B_{P}+N_{B}*B_{B},
where N_{I} is a number of I-frames in the GOP n, N_{P} is a number of P-frames in the GOP n, and N_{B} is a number of B-frames in the GOP n. The number of I-frames and P-frames can then be determined using the above relation. VBV buffer levels are simulated from the first frame in the GOP n to the last frame in the GOP n (715). A determination is made (720) as to whether there are any VBV violations by determining whether the following conditions are met for each frame j:
Bⱼ<Vⱼ,Vⱼ−Bⱼ+R/F<Vₘₐₓ,
where Bⱼ is the number of bits allocated for frame j; Vⱼ is the VBV buffer level immediately before frame j is removed from the buffer; and Vₘₐₓ is the maximum VBV buffer size.

If there are no VBV violations, a cost function E (i.e., a mean square error) is computed (725):
E=(α−αₒₚₜ)²+(β−βₒₚₜ)².
If the calculated cost function is less than a previously estimated optimal value of E (730), optimal E, α, and β values are updated (735) as Eₒₚₜ=E, αₒₚₜ=α, and βₒₚₜ=β. If there are one or more VBV violations or after updating the cost function E and there is still room for α and β to be reduced (740):
α>1.0,
β>1.0,
the values of α and β are updated (745):
α=α−0.1,
β=β−0.1,
and the algorithm 700 returns to proportionally re-allocate bits among I-frames, P-frames, and B-frames (710) using the new values of α and β. Otherwise, bits are allocated for the GOP using the optimal α and β values (750). As an example, an optimal a value is typically around eight to one for a 1080i source with a GOP size of fifteen frames and six to one for a 720p source with a GOP size of six frames and an optimal β value is typically around four to one for a 1080i source with a GOP size of fifteen frames and three to one for a 720p source with a GOP size of six frames. In some implementations, empirically determined optimal values for α and β are used as the initial values α₀ and β₀, and the goal is to find optimal α and β values using the algorithm 700 that are greater than 1.0, that are as close as possible to the initial values α₀ and β₀, and that do not result in a VBV violation.

Various implementations of the systems and techniques described here can be realized in digital electronic circuitry, integrated circuitry, specially designed ASICs (application specific integrated circuits), computer hardware, firmware, software, and/or combinations thereof. These various implementations can include one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) may include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., a data server), a middleware component (e.g., an application server), and a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), a personal area network (“PAN”), a mobile communication network, and/or the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made. For example, although the invention is described in the context of MPEG2 encoding, the invention can also be used in connection with other types of encoders that have interframe dependencies, such as H.264. Accordingly, other implementations are within the scope of the following claims.

What is claimed is:

1. A method for encoding data, the method comprising:
identifying a data segment to be encoded, the data segment including a plurality of frames;
generating a bit-rate profile for encoding the data segment, the bit-rate profile defining a number of bits associated with each frame in the data segment; and
encoding frames in the data segment using the bit-rate profile.

2. The method of claim 1 wherein generating a bit-rate profile comprises allocating a number of bits for each frame based on a type of interframe dependency for the frame.

3. The method of claim 1 wherein the data segment comprises a second portion of an edited video segment, a first portion of the edited video segment encoded using constant bit-rate encoding.

4. The method of claim 1 further comprising iteratively generating a bit-rate profile for encoding the data segment and encoding each frame in a group of frames using the bit-rate profile, wherein a new bit-rate profile is generated for remaining frames in the data segment after each encoding of a group of frames.

5. The method of claim 1 wherein the data segment comprises an edited video segment in a video sequence, the video sequence includes an adjacent video segment to the edited video segment, and the adjacent video segment has an associated buffer state used in generating the bit-rate profile.

6. The method of claim 1 wherein encoding frames using the bit-rate profile comprises adapting an encoding bit rate to correspond to the bit-rate profile.

7. The method of claim 1 wherein encoding frames using the bit-rate profile comprises selecting at least one quantization level for encoding a frame based on the number of bits associated with the frame from the bit-rate profile.

8. The method of claim 7 wherein the quantization level comprises at least one of a quantization step size or a scaling factor and the selected quantization level allows encoding of the frame using a number of bits within a predetermined threshold of the number of bits associated with the frame.

9. The method of claim 1 wherein the bit-rate profile is associated with a calculated buffer level for storage of bits from a data sequence that includes the data segment and generating the bit-rate profile is based on at least one factor selected from the group consisting of a target bit rate, a maximum calculated buffer level, a minimum calculated buffer level, and at least one boundary condition for the calculated buffer level.

10. An article comprising a machine-readable medium storing instructions for causing data processing apparatus to:
identify a data segment to be encoded, the data segment including a plurality of frames;
allocate a number of bits to each frame in the data segment in accordance with a target encoding bit rate and boundary conditions associated with the data segment to be encoded, the allocated number of bits for use in encoding the frame; and
adapt an encoder to encode a frame based on the allocated number of bits for the frame.

11. The article of claim 10 wherein the machine-readable medium stores instructions for causing data processing apparatus to:
identify a data sequence to be encoded, the data sequence including the data segment;
determine that a length of the data sequence exceeds a threshold; and
encode a portion of the data sequence in accordance with the target encoding bit rate in response to determining that the length of the data sequence exceeds the threshold, wherein a result of encoding the portion of the data sequence provides one of the boundary conditions associated with the data segment to be encoded.

12. The article of claim 10 wherein the boundary conditions comprise a calculated buffer level for a first data segment preceding the data segment to be encoded and a calculated buffer level for a second data segment following the data segment to be encoded.

13. The article of claim 10 wherein the plurality of frames are partitioned into groups of frames and the machine-readable medium stores instructions for causing data processing apparatus to re-allocate a number of bits to each remaining un-encoded frame in the data segment after encoding each group of frames.

14. The article of claim 13 wherein the machine-readable medium stores instructions for causing data processing apparatus to:
repeatedly adapt the encoder to encode a remaining un-encoded frame based on a re-allocated number of bits; and
repeatedly re-allocate a number of bits to each remaining un-encoded frame in the data segment after encoding each group of frames.

15. The article of claim 14 wherein the encoder is adapted to encode each frame based on the re-allocated number of bits by altering quantization levels used to encode each frame.

16. A method for single-pass video encoding, the method comprising:
identifying a video segment to be encoded, the video segment including a plurality of frames;
identifying at least an ending boundary condition for encoding the video segment, the boundary condition relating to a calculated buffer state;
calculating a number of bits allocated to each frame in at least a subset of the plurality of frames, the allocated number of bits for encoding each frame in accordance with a target encoding bit rate and based on the boundary condition; and
encoding each frame of the subset in accordance with the allocated number of bits.

17. The method of claim 16 wherein encoding each frame in accordance with the allocated number of bits comprises adapting a compression rate for each frame to encode each frame using a number of bits within a predefined limit of the allocated number of bits.

18. The method of claim 17 wherein encoding at least one frame comprises selecting a compression rate that does not result in using a number of bits that exceeds the allocated number of bits.

19. The method of claim 16 wherein calculating a number of bits allocated to each frame comprises calculating a ratio between at least two of a number of bits for I-frames, a number of bits for P-frames, or a number of bits for B-frames.

20. The method of claim 19 further comprising favoring a selection, for use in calculating a number of bits allocated to each frame, of a relatively higher ratio of at least one of a number of bits for P-frames to a number of bits for I-frames or a number of bits for B-frames to a number of bits for I-frames.

21. The method of claim 16 further comprising adjusting an allocated number of bits for at least one frame to prevent a calculated buffer from violating a minimum threshold.

22. The method of claim 16 wherein calculating the allocated number of bits comprises calculating a number of bits for each frame to enable the encoded video segment to comply with the boundary condition and to maintain a substantially consistent video quality.

23. The method of claim 16 wherein the video segment comprises a first portion and the subset of the plurality of frames comprises a second portion of the video segment, the method further comprising encoding the first portion using constant bit-rate encoding in accordance with a maximum threshold for the calculated buffer level, a minimum threshold for the calculated buffer level, and the target encoding bit rate, wherein encoding the second portion is substantially constrained by the allocated number of bits for each frame, the allocated number of bits calculated in accordance with the maximum threshold for the calculated buffer level, the minimum threshold for the calculated buffer level, the target encoding bit rate, and the boundary condition.

24. An article comprising a machine-readable medium storing instructions for causing data processing apparatus to:
identify a video segment to be encoded, the video segment including a plurality of frames;
identify a beginning boundary condition and an ending boundary condition for encoding the video segment, each boundary condition comprising a calculated buffer level;
calculate a number of bits allocated to each frame in the video segment, the allocated number of bits for encoding each frame to maintain a substantially consistent video quality and to ensure that the calculated buffer level does not exceed a maximum threshold for the calculated buffer level or fall below a minimum threshold for the calculated buffer level and that the encoded video segment satisfies the ending boundary condition, wherein changes in the calculated buffer level are associated with differences between an encoding bit rate for the frames and a target encoding bit rate; and
adapt an encoder to encode each frame using approximately the allocated number of bits for the frame.

25. The article of claim 24 wherein the machine-readable medium stores instructions for causing data processing apparatus to monitor the calculated buffer level starting from the beginning boundary condition through encoding of the video segment.

26. The article of claim 24 wherein the number of bits allocated to each frame in the video segment is calculated to ensure that an encoded frame includes spare bits for meeting the ending boundary condition.
